(19) United States
(12) Patent Application Publication
(10) Pub. No.: US 2021/0155448 A1
(43) Pub. Date: May 27, 2021

(54) Lift System Having a Slotted Hollow Conductor Arrangement

(71) Applicant: thyssenkrupp Elevator Innovation and Operations AG, Essen (DE)

(72) Inventors: Markan Lovric, Stuttgart (DE); Martin Madera, Neuhausen (DE); Petros Burutjis, Lichtenstein/Unterhausen (DE)

(73) Assignee: thyssenkrupp Elevator Innovation and Operations AG, Essen (DE)

(21) Appl. No.: 15/733,754

(22) PCT Filed: Apr. 4, 2019
(86) PCT No.: PCT/EP2019/058479

§ 371 Date: Oct. 16, 2020

(30) Foreign Application Priority Data
Apr. 17, 2018 (DE) 10 2018 205 825.3

(51) Int. Cl. B66B 1/34; B66B 9/00; B66B 7/02

(52) U.S. Cl. CPC B66B 1/3461; B66B 2201/30; B66B 7/02; B66B 9/003

(57) ABSTRACT

A lift system includes at least one travel rail mounted in a shaft, and a lift car having a chassis that is disposed on and movable along the travel rail in a travel direction. Also mounted in the shaft is a slotted hollow conductor having a slot defined therein extending in the travel direction. A holding arrangement that holds a cabin antenna extending therefrom is further coupled to, and movable with, the lift car in the travel direction, such that the cabin antenna protrudes into an interior of the slotted hollow conductor through the slot, and is movable along the length of the slot as the car moves in the travel direction. An antenna guide extends parallel to the travel direction of the lift car and is configured to guide the cabin antenna in the slot of the slotted hollow conductor.

### TECHNICAL FIELD

The invention relates to a lift system.

### TECHNICAL BACKGROUND

DE 10 2014 220 966 A1 discloses a lift system in which a plurality of lift cabins are operated cyclically in a circulating manner, similar to a paternoster. In contrast to the classic paternoster, each cabin is driven independently of the other cabins, and can thus stop at any desired stopping point independently of the other cabins. Transfer devices are provided in order to transfer the cabins from a vertical travel direction into a horizontal travel direction, so that in this way the cabin can be moved between different lift shafts. The lift cabins can thus be moved on a level that extends through the two lift shafts and the transfer shafts that connect them. In such a lift system, it is no longer possible to realize a data connection between the lift cabins and a central lift controller by means of a travelling cable, as has been done until now. One possibility for the data connection consists in wireless transmission paths. High requirements for safety, reliability and speed must, however, be met here.

Safety-relevant data signals relating to the speed of travel or a command for emergency braking in particular require reliable, fast data transmission. It has been found in this context that due to reinforced concrete components, metal cabins and metal rails, radio paths cannot be maintained with sufficient reliability in a lift shaft using simple WLAN hotspots.

In the German patent application 10 2016 223 147.2 it is proposed that a slotted hollow conductor arrangement is provided for the data transmission between components that are fixed to the shaft and components at the cabins. Through a sophisticated mode of operation, redundancy is even ensured when individual antennas leave the slot of the slotted hollow conductor for a period of time in the region of a conductor gap.

### DISCLOSURE OF THE INVENTION

It is the object of the invention to improve the reliability of the data connection for a lift system, in particular of the type mentioned at the beginning. The object underlying the invention is achieved through a lift system as claimed in claim 1; preferred embodiments emerge from the subsidiary claims as well as from the description.

The lift system according to the invention comprises:

at least one travel rail that is mounted in a shaft and at least one lift car with a chassis, and a slotted hollow conductor arrangement. A plurality of lift cars are in particular provided. The chassis can be moved along the travel rail in a travel direction. The slotted hollow conductor arrangement comprises a slotted hollow conductor that is mounted in the shaft, and a cabin antenna that is attached to the lift car and can be moved in the shaft together with the lift car. The cabin antenna protrudes through a slot of the slotted hollow conductor into an interior of the slotted hollow conductor.

The cabin antenna is held flexibly with respect to the lift car by a holding arrangement, and the cabin antenna is guided with respect to the slotted hollow conductor by means of an antenna guide, parallel to the travel direction.

The advantage of this arrangement lies in that the antenna is essentially decoupled from a possible relative movement of the lift car with respect to the guide rails. The separate guide of the cabin antenna, in combination with the movability of the cabin antenna with respect to the lift car, nevertheless enables a sufficiently precise guidance of the cabin antenna in the slot of the slotted hollow conductor. Elastic deformations in certain regions, which in particular can occur as a result of a backpack mounting, are here also viewed as a relative movement of the lift car.

“Guide rails” refers here to the rails that are provided to guide the cabin antenna with respect to the slotted hollow conductor. The in particular separate rails for guiding the lift car in the shaft are referred to as travel rails.

In one form of embodiment, the lift car comprises a chassis and a lift cabin, wherein the holding arrangement is fastened at least indirectly to the lift cabin via the chassis. The rollers for guiding the lift car are in particular arranged at the chassis. A catch frame of the lift car can also be viewed as the chassis. The lift cabin is designed to accommodate the passengers. The chassis can be designed integrally with the lift cabin.

In one form of embodiment, the antenna guide comprises a guide rail and a guide member, wherein the guide rail is rigidly connected to the slotted hollow conductor, and wherein the guide member is rigidly connected to the cabin antenna. Rigid in this context signifies in particular a flexibility that is restricted in such a way that a predefined free play can be maintained between the antenna and the slot.

In one form of embodiment, the guide member is pressed onto the guide rail by means of a normal force. The pressing here counteracts an unintended release of the guide member from the guide rail. Normal force does not mean that the force has to act exactly perpendicularly to the guide rail. Rather is it necessary for a perpendicularly active force component to be present which brings about the desired pressing of the guide member against the guide rail.

In one form of embodiment, the holding arrangement comprises an antenna carrier to which the cabin antenna and the guide member are fastened. The antenna carrier is thus a connecting piece between the cabin antenna and the guide means in a common reference system of the cabin antenna and the guide member.

Gaps in the conductor may necessarily result in particular at transitions of the travel rails (in particular when a travel rail is movable). The conductor gap can be a very small slot, in particular of less than 1 mm.

In one form of embodiment, the guide rail comprises a first guide rail segment and a second guide rail segment that are formed separately from one another at a conductor gap. The guide rail comprises a guide segment and a threading segment adjacent to it in a travel direction. The threading segment is arranged between the conductor gap and the guide segment. The guide member can be guided with a greater free play at the threading segment than at the guide segment.

The threading segment comprises in particular an opening that widens in the direction of the conductor gap. A guide member that enters the threading segment from the direction of the conductor gap while not optimally aligned can be accepted in spite of the lack of guidance from the threading segment. The guidance in the threading segment is therefore more tolerant, which can be noticed in the greater free play in the guide.

In one form of embodiment, the holding arrangement and the antenna guide can interact with one another in such a way that, when the guide member transfers from a first guide rail segment to a second guide rail segment, the guide member is guided with a low free play through the first guide segment of the first guide rail segment at least until the guide member can be guided by the threading segment of the second guide rail segment. The effect of this here is that the guide member is therefore guided by the first guide segment long enough for the second threading segment to take over the guidance.

In one form of embodiment, the holding arrangement and the antenna guide can interact with one another in such a way that, when the guide member transfers from a first guide rail segment to a second guide rail segment, the guide member is guided with a low free play through the first guide segment of the first guide rail segment at least until the guide member can be guided by the guide segment of the second guide rail segment. The effect of this here is that the guide member is therefore guided by the first guide segment long enough for the second guide segment to take over the guidance. Guidance with low free play is always ensured in this case.

In one form of embodiment, a length of the guide member is at least twice as great as a minimum spacing between the first guide segment of the first guide rail segment and the second threading segment of the second guide rail segment.

In one form of embodiment, a length of the guide member is at least half as great as a minimum spacing between the first guide segment of the first guide rail segment and the second guide segment of the second guide rail segment.

In one form of embodiment, the lift system comprises at least one stationary first guide rail that is permanently aligned in a first, in particular vertical, direction, as well as at least one stationary second guide rail that is permanently aligned in a second, in particular horizontal, direction. The lift system comprises at least one transfer unit for transferring the lift car from a travel in the first direction to a travel in the second direction. The transfer unit in particular comprises at least one movable, in particular rotatable, third guide rail. The third guide rail in particular can be transferred between a first position, in particular an alignment in the direction, and a second position, in particular an alignment in the second direction.

### SHORT DESCRIPTION OF THE DRAWING

The invention is explained in more detail below with reference to the figures. Here, shown schematically in each case,

FIG. 1 shows a perspective illustration of a lift system according to the invention in detail form;

FIG. 2 shows a plan view of parts of the data-transmission elements of the lift system of FIG. 1;

FIG. 3 shows a different lateral cutaway view of details of embodiments of the data transmission structure of FIG. 1.

### DESCRIPTION OF FORMS OF EMBODIMENT

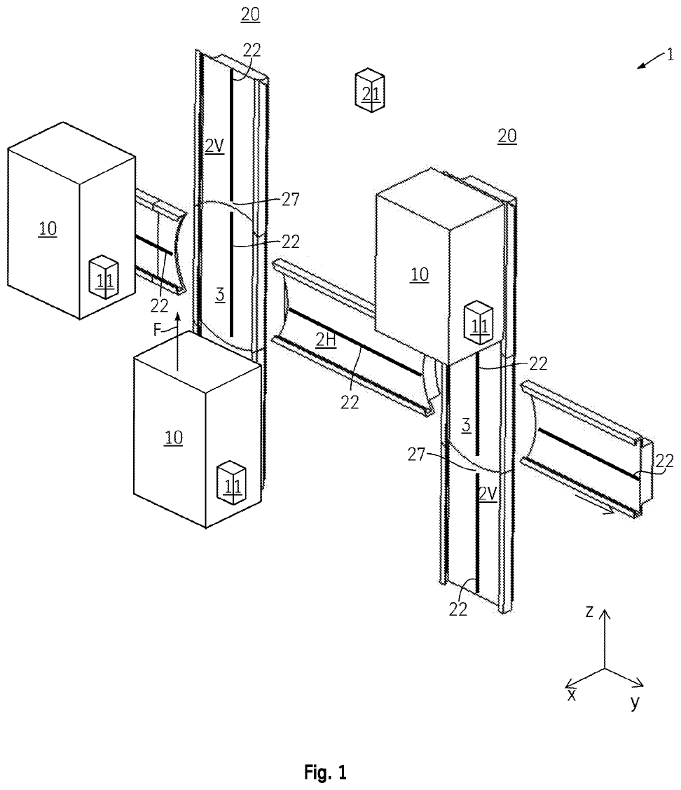

FIG. 1 shows parts of a lift system 1 according to the invention. The lift system 1 comprises a plurality of travel rails 2, along which multiple lift cars 10 can be guided making use of a backpack mounting. A vertical travel rail 2V is aligned vertically in a first direction, and makes it possible for the guided lift car 10 to be moved between different floors. Multiple vertical travel rails 2V are arranged in adjacent shafts 20 in this vertical direction.

A horizontal travel rail 2H is arranged between the two vertical travel rails 2V, along which a lift car 10 can be guided making use of a backpack mounting. This horizontal travel rail 2H is aligned horizontally in a second direction, and makes it possible for the lift car 10 to be moved within one floor. The horizontal travel rail 2H further connects the two vertical travel rails 2V to one another. The second travel rail 2H plus also serves to transfer the lift car 10 between the two vertical travel rails in order, for example, to perform a modern paternoster operation. Multiple such horizontal travel rails 2H, not illustrated, which connect the two vertical travel rails to one another, are provided in the lift system.

The lift car 10 can be transferred between a vertical travel rail 2V and a horizontal travel rail 2H by means of a transfer unit with a movable, in particular rotatable, travel rail 3. All the travel rails 2, 3 are at least indirectly installed in a shaft wall 20. Such lift systems are basically described in WO 2015/144781 A1, as well as in the German patent applications 10 2016 211 997.4 and 10 2015 218 025.5.

Cabin control units 11 are installed at each of the lift cars 10, and move along the travel rails with the lift cars. These cabin control units 11 are in data contact with a central control unit 21 of the lift system 1. Since travelling cables cannot be used in such lift systems, the data transmission must be realized in another manner. Sliding contacts have been found to be subject to wear, as a result of which a wireless data transmission between the cabin control units 11 and the central control unit 21 is used. In the context of the invention, a slotted hollow conductor arrangement is used for the wireless data transmission, as is basically described in the German patent application 102016223147.2.

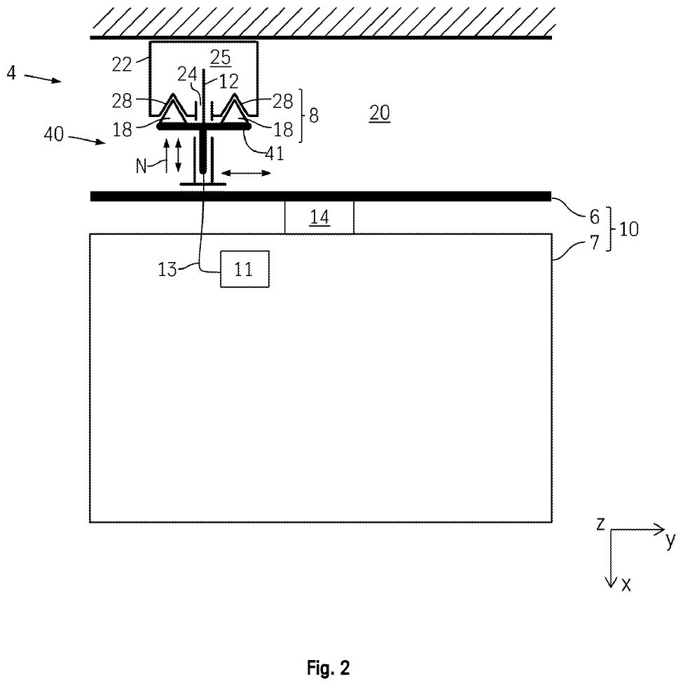

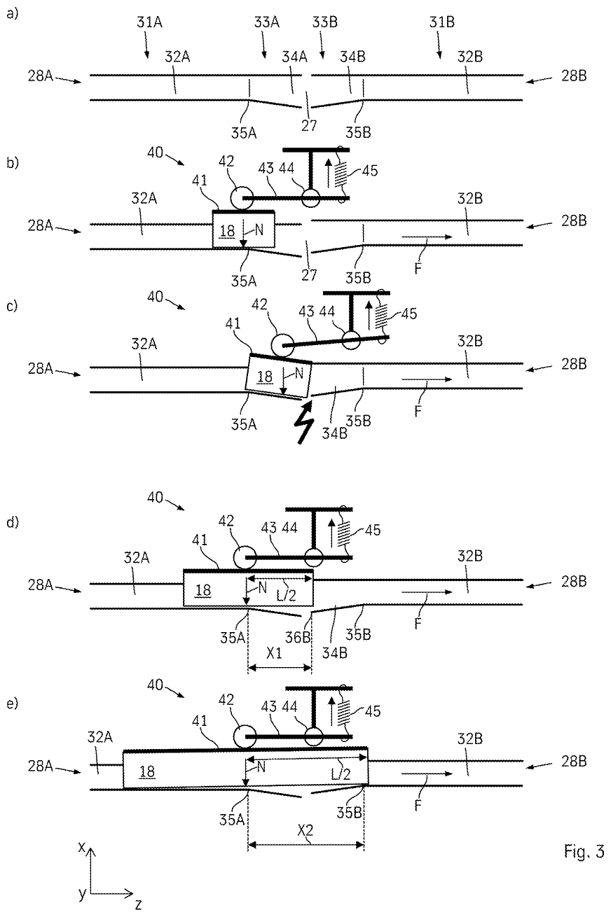

The wireless data transmission to the cabin control units 11 takes place on the basis of at least one slotted hollow conductor arrangement 4, as is further described in more detail with reference to FIGS. 2 and 3. In this respect, FIG. 1 shows slotted hollow conductors 22 of this slotted hollow conductor arrangement 4, which are installed along the travel rails in the shaft 2, 3. In the area of the transfer unit, the slotted hollow conductor 22 can be moved, in particular rotated, together with the movable travel rail. In the region between the movable rail 3 and one of the fixed rails 2, a conductor gap 27 necessarily results, in which the slotted hollow conductor 22 is interrupted.

The slotted hollow conductor arrangement 4 is shown in section in FIG. 2 along the sectional line II-II of FIG. 1. The travel rails and rollers for guiding the cabin 10 are not shown here.

A slotted hollow conductor arrangement 4 comprises the slotted hollow conductors 22, already mentioned, that are installed in the shaft 20. A cabin antenna 12 is inserted into an interior of the slotted hollow conductor 22 through a slot 24 of the slotted hollow conductor 22 that runs parallel to the travel direction FV or FH (parallel to the z direction in FIG. 2). The cabin antenna 12 is connected to the lift car 10 in such a way that a wired data connection 13 is possible between the cabin antenna 12 and the cabin control unit 11. The cabin antenna 12 can be moved in the shaft 20 with the lift car 10.

The lift car 10 comprises two main components, namely a lift cabin 7 and a chassis 6. Rollers, not illustrated, for guiding the lift car are attached to the guide rails 2 at the chassis 6. Passengers can be accommodated in the lift cabin 7. In this case, the chassis 6 is designed separately from the lift cabin 7, a rotary joint 14 being arranged between the chassis 6 and the lift cabin 7. When transferring, the chassis 6, together with the rotating travel rail 3, can thus be turned with respect to the lift cabin 7. Such an arrangement is described in DE 10 2014 104 458 A1, wherein the chassis (German: Fahrgestell) is referred to there as a “Chassis”. The chassis 6 and the lift cabin 7 can, in principle, also be permanently connected to one another, for example being designed integrally. The cabin antenna 12 is fastened here to the chassis 6.

The fastening of the cabin antenna 12 to the lift car 10 is done in such a way that there is free play, so that relative movements transverse to the travel direction (in the x and/or y direction in FIG. 2) between the chassis 6 and the slotted hollow conductor 22 can be compensated for. A holding arrangement 40 is provided for this purpose, and ensures a flexible but fundamentally permanent connection between the lift car 10 and the cabin. An antenna guide 8 is provided at the same time, and ensures that the cabin antenna 12 is guided with respect to the slotted hollow conductor in such a way that a reliable data transmission is ensured at the slotted hollow conductor arrangement 4.

The antenna guide 8 comprises a guide rail 28 that is arranged with a defined alignment with respect to the slotted hollow conductor, and is aligned in the travel direction FV or FH. The guide rail 28 can be designed as one piece with a housing of the slotted hollow conductor 22, or can be attached to this housing permanently, screwed to it for example. The antenna guide 8 further comprises a guide member 18 that is arranged with a defined alignment with respect to the cabin antenna 12. In the present exemplary embodiment, the antenna guide comprises two guide rails arranged parallel to one another, and two guide members 18 guided thereon.

The guide member 18 is pressed against the guide rail 28 by a normal force N, so that the guide member 18 is reliably held at the guide rail 28.

A cross-section of the guide rail 28 is designed to be complementary to the cross-section of the guide member 18. In this example, the cross-section is designed in the form of a wedge, which favors self-centering.

The way in which the holding arrangement, and the antenna guide, operate is explained in more detail with reference to the illustrations of FIG. 3, wherein FIG. 3 shows a lateral cutaway view, transverse to the travel direction F, of the holding arrangement as well as the antenna guide.

The guide rail 28 is shown in FIG. 3a. Like the slotted hollow conductor 22 as a whole, the guide rail 28 also has an interruption in the region of the conductor gap 27. The conductor gap 27 consequently divides the guide rail 28 into a first rail segment 28A and a second guide rail segment 28B that is adjacent to it in the travel direction F. Further along the shaft, the guide rail 28 comprises another plurality of further rail segments which are not, however, discussed here.

Each rail segment 28A, 28B comprises in each case a first and a second guide segment 31A, 32A, each of which has a first and second guide surface 32A, 32B. The guide surfaces 32A, 32B are aligned in the guide segment 31A, 32B parallel to the travel direction F, and enable a guidance of the guide member 18 with little guidance free play.

Between the guide segment and the conductor gap, rail segments 28A, 28B each have a first and second threading segment 33A, 33B, each of which has a first and a second threading surface 34A, 34B. The threading surface 34A, 34B represents the extension of the associated guide surface 32A, 32B, wherein the threading surface opens towards the direction of the conductor gap. The form of a funnel results, which should simplify the threading of the guide member, even if the two adjacent rail segments 28A, 28B are not aligned optimally with respect to one another. The guide member 18 is guided in the threading segment 33 with greater guidance free play than in the guide segment 31.

The threading segment 33 is provided to simplify the threading of the guide member 18 when the guide member at the conductor gap 27 meets the rail segment.

FIG. 3b shows a side view of a first embodiment of the holder arrangement 40, transverse to the travel direction F. The holding arrangement 40 comprises the antenna carrier 41 to which the cabin antenna 41 (FIG. 2) is rigidly fastened. The guide member 18 is also rigidly fastened to the antenna carrier 41, so that the cabin antenna is always held in a defined manner with respect to the guide member.

The guide member is pressed against the guide rail 58 with a normal force N by means of a spring 45. A lever construction consisting of a carrier joint 42, holding arm 43, arm joint 44, permits the fastening, with free play, to the lift car, not illustrated.

The holding arrangement 40, in particular the joints 42, 44, are designed in such a way that the antenna carrier 41 is held movably in the directions x and y transverse to the travel direction F. A rigid coupling is provided parallel to the travel direction F, so that the antenna carrier 41 is reliably carried along in the travel direction by the lift car.

The guide rail segments 28A, 28B are shown for the purposes of illustration in FIGS. 3b to 3e aligned with respect to one another in such a way that a step is formed in the region of the conductor gap 27 transverse to the travel direction F, by way of example in this case in the x direction. As illustrated in FIG. 3c, this can have the result that when transferring from the first guide rail segment 28A to the second guide rail segments 28B, the guide member 18 strikes an edge of the threading segment (shown by the lightning flash in FIG. 3c). In a less serious case, the result is a slight impact loading on the adjacent components; in a serious case, this can lead to serious damage to components, in particular to destruction of the guide member 18, of the guide rail 28 or of the holding arrangement 40. This can have the result of interrupting the data connection, which in turn can lead to failure of the lift system.

This impact is occasioned by a tilting of the guide member 18 as it enters the first threading segment 33A. This tilting in turn is occasioned by the loss of the tight guidance in the first guide segment 32A, or by the occurrence of increased free play in the threading segment, in combination with the subjection of the guide member 18 to the normal force N.

In order to avoid this disadvantageous effect, the length of the guide member in the travel direction F is increased in comparison with the first embodiment.

In a second embodiment (FIG. 4d) the length of the guide member 18 is chosen such that the first guide rail segment 28A only allows the guide member 18 to be tilted by the normal force N when the guide member 18 has entered into the second threading segment 33B. Half of the length L/2 of the guide member 18 is here at least as large as the spacing X1 between the end of the first guide segment 32A (which is the guidance end 35A) and the start of the second threading segment 34B (which is the threading point 36B).

In a third embodiment (FIG. 4e) the length of the guide member 18 is chosen such that the first guide rail segment 28A only allows the guide member 18 to be tilted by the normal force N when the guide member 18 has entered into the second guide segment 31B. Half of the length L/2 of the guide member 18 is here at least as large as the spacing X2 between the end of the first guide segment 32A (which is the guidance end 35A) and the start of the second guide segment 34B (which is the guidance start 35B). In point of fact, tilting of the guide member 18 as a result of the normal force N is prevented in this way.

The second and the third embodiment consequently have increased security against uncontrolled movements of the guide member in the region of the threading segments.

### LIST OF REFERENCE SIGNS

1 Lift system
2 Travel rail
3 Rotatable rail segment
4 Slotted hollow conductor arrangement
6 Chassis
7 Lift cabin
8 Antenna guide
10 Lift car
11 Cabin control unit
12 Cabin antenna
13 Wired data connection
14 Rotary joint
18 Guide member
20 Shaft
21 Central control unit
22 Slotted hollow conductor
23 Transition
24 Slot
25 Interior
26
27 Conductor gap
28 Guide rail
28A, 28B Guide rail segment
31 Guide segment
32 Guide surface
33 Threading segment
34 Threading surface
35A, 35B Guidance end/Guidance start
36B Threading point
40 Holding arrangement
41 Antenna carrier
42 Carrier joint
43 Holding arm
44 Arm joint
45 Tensioning spring
F Travel direction
L Length of the guide member
L/2 Half of the length of the guide member
X Spacing

1.-10. (canceled)

11. A lift system, comprising:
a travel rail mounted in a shaft;
a lift car having a chassis disposed on, and movable along, the travel rail in a travel direction;
a slotted hollow conductor assembly, comprising a slotted hollow conductor mounted in the shaft and having a longitudinal slot defined therein extending along a longitudinal length thereof parallel with the travel direction;
a holding arrangement coupled to the lift car;
a cabin antenna flexibly held in, and extending from, the holding arrangement such that it is coupled to, and movable with, the lift car in the shaft, which antenna protrudes into an interior of the slotted hollow conductor through the longitudinal slot; and
an antenna guide extending parallel to the travel direction and configured to guide the cabin antenna in the slot of the slotted hollow conductor.

12. The lift system of claim 11, wherein the antenna guide comprises a guide rail rigidly connected to the slotted hollow conductor, and a complimentary guide member rigidly connected to the cabin antenna, the guide rail configured to guide the guide member in the travel direction.

13. The lift system of claim 12, wherein the guide member is biased against the guide rail by a normal force.

14. The lift system of claim 11, wherein the holding arrangement comprises an antenna carrier, and wherein the cabin antenna and the guide member are coupled to the antenna carrier.

15. The lift system of claim 12, wherein the guide rail comprises:
a first guide rail segment, and a separate second guide rail segment disposed adjacent the first guide rail segment in the travel direction, between which first and second guide rail segments is defined a conductor gap; and
a guide segment adjacent to a threading segment in the travel direction, wherein the threading segment is disposed between the conductor gap and the guide segment, wherein a greater amount of guidance free play exists between the guide member and the guide rail at the threading segment than at the guide segment.

16. The lift system of claim 15, wherein the holding arrangement and the antenna guide are configured such that, when the lift car is moving in the travel direction, and the guide member transfers from a first guide rail segment to a second guide rail segment, the guide member is guided with a low amount of guidance free play through the first guide segment of the first guide rail segment, at least until the guide member can be guided by the threading segment of the second guide rail segment.

17. The lift system of claim 15, wherein the holding arrangement and the antenna guide are configured such that, when the lift car is moving in the travel direction, and the guide member transfers from a first guide rail segment to a second guide rail segment, the guide member is guided with a low amount of guidance free play through the first guide segment of the first guide rail segment, at least until the guide member can be guided by the guide segment of the second guide rail segment.

18. The lift system of claim 15, wherein a length of the guide member is at least twice as large as the distance between the first guide segment of the first guide rail segment and the second threading segment of the second guide rail segment.

19. The lift system of claim 15, wherein a length of the guide member is at least twice as large as the distance between the first guide segment of the first guide rail segment and the second guide segment of the second guide rail segment.

20. The lift system of claim 11, further comprising:
a stationary first guide rail permanently aligned in a first direction;
a stationary second guide rail permanently aligned in a second direction;
at least one transfer unit configured to transfer the lift car from a travel in the first direction to a travel in the second direction, the transfer unit having at least one rotatable third guide rail that can be rotatably transferred between a first position in alignment with the first direction, and a second position in alignment with second direction.
